(19) United States
(12) Patent Application Publication
(10) Pub. No.: US 2019/0359510 A1
(43) Pub. Date: Nov. 28, 2019

(54) COOPERATIVE OPTIMAL CONTROL METHOD AND SYSTEM FOR WASTEWATER TREATMENT PROCESS

(71) Applicant: BEIJING UNIVERSITY OF TECHNOLOGY, Beijing (CN)

(72) Inventors: HONGGUI HAN, BEIJING (CN); LU ZHANG, BEIJING (CN); JUNFEI QIAO, BEIJING (CN)

(21) Appl. No.: 16/109,651

(22) Filed: Aug. 22, 2018

(30) Foreign Application Priority Data
May 23, 2018 (CN) 201810499231.X

(51) Int. Cl. C02F 3/00; C02F 1/58

(52) U.S. Cl. CPC C02F 3/006; C02F 2101/163; C02F 2209/04; C02F 1/586

(57) ABSTRACT

In a cooperative optimal control system, firstly, two-level models are established to capture the dynamic features of different time-scale performance indices. Secondly, a data-driven assisted model based cooperative optimization algorithm is developed to optimize the two-level models, so that the optimal set-points of dissolved oxygen and nitrate nitrogen can be acquired. Thirdly, a predictive control strategy is designed to trace the obtained optimal set-points of dissolved oxygen and nitrate nitrogen. This proposed cooperative optimal control system can effectively deal with the difficulties of formulating the dynamic features and acquiring the optimal set-points.

### CROSS REFERENCE TO RELATED APPLICATION

This application claims priority to Chinese Patent Application No. 201810499231.X, filed on May 23, 2018, entitled “Cooperative optimal control system for wastewater treatment process”, which is hereby incorporated by reference in its entirety.

### TECHNICAL FIELD

In this present invention, a cooperative optimal control system (COCS) is designed to coordinate the different time-scale performance indices, realize the real-time optimal control of wastewater treatment process (WWTP), and improve the system performance. It is feasible to apply the proposed COCS to the dynamic WWTP, and realize the tracking control of the dissolved oxygen (S_{O}) and the nitrate nitrogen (S_{NO}). This system can not only address the cooperative problem of the different performance indices, but also conserve the operation cost, improve the effluent quality, and guarantee the efficient stable operation. The technology of this present invention is a part of advanced manufacturing technologies, which belongs to the field of control engineer and wastewater treatment engineer.

### BACKGROUND

WWTP is conducted to effectively adsorb, decompose and oxidize the pollutants based on the physical, chemical and biological reaction, so that the pollutants can be degraded and separated from the wastewater, thereby realizing the purification. The efficient operation plays an important role in improving the optimal control performance and optimizing the system performance, which is an important strategy for alleviating scarcity of water resources. It has not only good economic benefits, but also significant environmental and social benefits. Therefore, the research results of the present invention have broad application prospects.

WWTP is a complex industrial system, and it has obvious nonlinearity and time-varying features. In addition, WWTP comprises different dynamic response time, multiple performance evaluation indices, which make it difficult to realize the optimal control. Since the performance indices are conflicted with each other, and influenced by different system response time, how to achieve the cooperation between the performance indices with different time scales is of great significance to improve the system performance and ensure its efficient and stable operation. It is significant to improve the operation performance based on the cooperative performance indices, which can not only improve the optimal operations, but also guarantee the control performance. Therefore, it is necessary to explore a novel optimal control method, where different time-scale performance indices can be formulated, and the optimal set-points of the control variables can be acquired, so that the requirements of the optimal control can be satisfied. Appropriate optimal control method can not only adjust the relationship of the performance indices, so as to guarantee the effluent quality and reduce the operation cost, but also provide suitable dynamic optimal set-points to reduce and cope with the occurrence of the abnormal conditions, and ensure the efficient and stable operation. In addition, by improving the automation level of WWTP, it can also effectively decrease the operation management and operation personnel, as well as minimize the operation cost.

### SUMMARY

In this present invention, a COCS is designed for WWTP, where the different time-scale performance indices models are formulated based on the system response time, the different time-scale performance indices models are then optimized by cooperative optimization algorithm, so that the optimal set-points of S_{O} and S_{NO} can be obtained, and then a predictive control strategy is designed to trace the obtained optimal set-points of S_{O} and S_{NO}. In this present invention, a COCS is designed. This proposed COCS can address the different time-scale performance indices formulation problem by the two-level performance indices models. It can optimize the multiple time-scale performance indices by the cooperative optimization algorithm based on the data-driven assisted model, so that the problem about the optimal set-points of S_{O} and S_{NO} can be solved. Moreover, a predictive control strategy is designed to trace the obtained optimal set-points of S_{O} and S_{NO}. Based on COCS, not only the multiobjective optimal control problem can be approached, but also the performance indices can be improved, as well as the efficient and stable operation.

This invention develops a COCS for WWTP. This proposed COCS can solve the problem of description of performance indexes at different time scales by using a two-layer performance index modeling method; and utilize a cooperative optimization algorithm based on a data driven assisted model to solve the problem. The different time-scale performance index models are then optimized by the cooperative optimization algorithm, where the set-points of S_{O} and the concentration of S_{NO} can be obtained. Then a predictive control strategy is developed to trace the obtained optimal set-points of S_{O} and S_{NO}. Based on the proposed COCS, not only the system performance can be improved, but also efficient and stable operation can be guaranteed.

A cooperative optimal control system is developed for WWTP, its features include the design of control system framework and the optimal controller, the specific steps are:

(1) the design of the control system framework, the steps are:

1) the control system includes the serve, the PLC control cabinet, the blower, an oxidation-reduction potential (ORP) electrode sensor, a S_{O} sensor, a suspend solid (SS) sensor, a temperature sensor, a pH sensor, an ammonia nitrogen (S_{NH}) sensor, a total nitrogen (TN) sensor, a chemical oxygen demand (COD) sensor, where

the serve is the operation center of control system to optimize the control procedure and realize the monitoring functions;

the PLC control cabinet is used to complete the automatic detection, monitor and control of the equipment status and operation conditions;

the blower acts as an executor of the control system to realize the aeration and ventilation of aerobic tank;

an ORP electrode sensor, located in the anaerobic tank, is configured to measure the values of ORP;

a S_{O} sensor, located in the aerobic tank, is configured to measure the values of S_{O};

a SS sensor, located in the aerobic tank, is configured to measure the values of SS;

a temperature sensor, located in the effluent tank, is configured to measure the values of temperature;

a pH sensor, located in the in the effluent tank, is configured to measure the values of pH;

a S_{NH} sensor, located in the effluent tank, is configured to measure the values of S_{NH};

a TN sensor, located in the effluent tank, is configured to measure the values of TN;

a COD sensor, located in the effluent tank, is configured to measure the values of COD;

2) data collection and transmission in WWTP, first, it is necessary to achieve the data acquisition through an ORP electrode sensor, a S_{O} sensor, a SS sensor, a temperature sensor, a pH sensor, a S_{NH} sensor, a TN sensor, a COD sensor; then it is essential to connect the PLC control cabinet and the sensors by using RS 485, realize the communication, complete the upload of the collected data, and transfer the collected data to the serve through the coordinated communication standards;

(2) the optimal controller, which comprises the establishment of performance indices, the development of optimization algorithm and the design of the controller, the steps are:

1) select the related process variables of the pumping energy (PE): S_{NO}, mixed liquor suspended solids (MLSS), and choose the related process variables of the aeration energy (AE) and the effluent quality (EQ): S_{O}, SS, S_{NH}, S_{NO};

2) formulate the two-level models based on the different time scales, the upper-level model is designed for PE, and the lower-level models are designed for AE and EQ:

F₁(t₁)=l₁(xᵤ(t₁)), (1)

f₁(t₂)=l₂(xₗ(t₂),xᵤ*(t₁)),

f₂(t₂)=l₃(xₗ(t₂),xᵤ*(t₁)), (2)

where F₁(t₁) is a model of the PE at time t₁, l₁(xᵤ(t₁)) is a mapping function of the PE model, f₁(t₂) is a model of the AE at time t₂, l₂(xₗ(t₂), x*ᵤ(t₁)) is a mapping function of the AE model, x*ᵤ(t₁) is an optimal set-points of nitrate nitrogen S_{NO}* at time t₁, f₂(t₂) is a model of the EQ at time t₂, l₃(xₗ(t₂), x*ᵤ(t₁)) is a mapping function of the EQ model, xᵤ(t₁)=[S_{NO}(t₁), MLSS(t₁)] is the input variables vector of the pumping energy at time t₁, S_{NO}(t₁) is concentration of nitrate nitrogen S_{NO} at time t₁, MLSS(t₁) is the concentration of the MLSS at time t₁, xₗ(t₂)=[S_{O}(t₂), SS(t₂), S_{NH}(t₂)], S_{O}(t₂) is the concentration of S_{O} at time t₂, SS(t₂) is the concentration of SS at time t₂, S_{NH}(t₂) is the concentration of S_{NH} at time t₂, and [S_{O}(t₂), SS(t₂), S_{NH}(t₂), S_{NO}*(t₁)] are input variables vector of AE and EQ at time t₂;

(3) design a cooperative optimization algorithm to optimize upper-level and lower-level optimization problems to obtain optimal set-points of control variables, an optimization period of upper level is two hours, and an optimization period of lower level is thirty minutes, which includes:

\textcircled{1} formulate the upper-level and lower-level problems:

Min F₁(S_{NO}(t₁),MLSS(t₁)), (3)

Min[f₁(S_{O}(t₂),S_{NH}(t₂),SS(t₂),S_{NO}*(t₁)),

f₂(S_{O}(t₂),S_{NH}(t₂),SS(t₂),S_{NO}*(t₁))], (4)

where Min F₁(S_{NO}(t₁), MLSS(t₁)) is the upper-level optimization problem, Min [f₁(S_{O}(t₂), S_{NH}(t₂), SS(t₂), S_{NO}*(t₁)), f₂(S_{O}(t₂), S_{NH}(t₂), SS(t₂), S_{NO}*(t₁))] is the lower-level optimization problem;

\textcircled{2} set the number of particle population in the upper level optimization I₁, the number of the particle population in the lower level optimization I₂, a maximum number of iterations in the upper level optimization N₁, and a maximum number of iterations in the lower level optimization N₂, I₁=50, I₂=50, N₁=20, N₂=50;

\textcircled{3} introduce a single particle swarm optimization (SPSO) algorithm to optimize the upper-level optimization problem, a position and a velocity of the ith particle are:

sᵢ(t₁)=[s_{i,1}(t₁),s_{i,2}(t₁)], (5)

vᵢ(t₁)=[v_{i,1}(t₁),v_{i,2}(t₁)], (6)

sᵢ(t₁) is the position of the ith particle at time t₁, s_{i,1}(t₁) is the value of S_{NO} at time t₁, s_{i,2}(t₁) is the value of MLSS at time t₁, vᵢ(t₁) is the velocity of the ith particle at time t₁, i is the number of particles, i=1, 2, . . . , 50, an update process of sᵢ(t₁) and vᵢ(t₁) are

v_{i,d}(t₁+1)=0.7v_{i,d}(t₁)+0.72(p_{i,d}(t₁)−s_{i,d}(t₁))+0.72₂(g_{d}(t₁)−s_{i,d}(t₁)), (7)

s_{i,d}(t₁+1)=s_{i,d}(t₁)+v_{i,d}(t₁+1), (8)

where d is the space dimension, d=1, 2, v_{i,d}(t₁) is the velocity of the ith particle in the dth dimension at time t₁, p_{i,d}(t₁) is the individual optimal solution of the ith particle in the dth dimension at time t₁, g_{d}(t₁) is the global optimal solutions of the ith particle at time t₁;

\textcircled{4} if SPSO reaches a preset maximum number of evolutions N₁, stop the iterative evolution process, transfer the value of S_{NO}* to the lower level; if SPSO does not reach the preset maximum number of evolutions N₁, return to step \textcircled{3};

\textcircled{5} introduce a multiobjective particle swarm optimization (MOPSO) algorithm to optimize the lower-level optimization problem, the position of the jth particle aⱼ(t₂) and the velocity of the jth particle bⱼ(t₂) can be represented as aⱼ(t₂)=[a_{j,1}(t₂), a_{j,2}(t₂), a_{j,3}(t₂), a_{j,4}(t₂)], a_{i,1}(t₂) represents the value of S_{O} at time t₂, a_{i,2}(t₂) represents the value of S_{NH} at time t₂, a_{i,3}(t₂) represents the value of SS at time t₂, a_{i,4}(t₂) represents the value of S_{NO}* at time t₂, bⱼ(t₂)=[b_{j,1}(t₂), b_{j,2}(t₂), b_{j,3}(t₂), b_{j,4}(t₂)], j is the number of particles, j=1, 2, . . . , 50; during the iterative evolution process, the obtained non-dominated solutions are conserved in the external archive Z(t₂), Z(t₂)=[z₁(t₂), z₂(t₂), . . . , zⱼ(t₂), . . . , z₅₀(t₂)], the update rule of the external archive is:

žⱼ(t₂)=zⱼ(t₂)+0.09∇D(zⱼ(t₂)), (9)

where zⱼ(t₂) is the jth non-dominated solution at time t₂ before the archive is updated, žⱼ(t₂) is the jth non-dominated solution at time t₂ after the archive is updated, zⱼ(t₂)=[z_{j,1}(t₂), z_{j,2}(t₂)], žⱼ(t₂)=[ž_{j,1}(t₂), ž_{j,2}(t₂)], z_{j,1}(t₂) and ž_{j,1}(t₂) are the values of S_{O} before and after the archive is updated, z_{j,2}(t₂) and ž_{j,2}(t₂) are the values of S_{NO} before and after the archive is updated, ∇D is the gradient descent direction;

\textcircled{6} establish a multi-input-multi-output radial basis assisted model (RBSM) based on the non-dominated solutions in Z(t₂):

$${B}_{j} ( {t}_{2} ) = {\sum }_{k = 1}^{8} {o}_{j , k} ( {t}_{2} ) \times {θ}_{j , k} ( {t}_{2} ) , \qquad ( 10 )$$

where Bⱼ(t₂) is an output vector of RBSM, Bⱼ(t₂)=[B_{j,1}(t₂), B_{j,2}(t₂)]^{T}, B_{j,1}(t₂) is a predicted value of the aeration energy at time t₂, B_{j,2}(t₂) is a predicted value of the effluent quality at time t₂, oⱼ(t₂)=[o_{j,1}(t₂), o_{j,2}(t₂), . . . , o_{j,8}(t₂)]^{T} are connection weights, θⱼ(t₂)=[θ_{j,1}(t₂), θ_{j,2}(t₂), . . . , θ_{j,8}(t₂)]^{T} is the output vector of the neurons in hidden layer, the sum of the squared errors between the output of RBSM and the actual system is expressed as

e(zₙ(t₂))=min(Bₙ(t₂)−Q(t₂))^{T}(Bₙ(t₂)−Q(t₂)), (11)

where e(zₙ(t₂)) is the sum of the squared errors between the outputs of the nth non-dominated solution Bₙ(t₂) and the actual system Q(t₂), n∈[1, I₂], Q(t₂)=[Q₁(t₂), Q₂(t₂)] is the real outputs of the aeration energy and effluent quality in the actual system, select the solution corresponding to the minimal sum of the squared error as the global optimal solution;

\textcircled{7} if MOPSO reaches the preset maximum number of evolutions N₂, stop the iterative evolution process and output the optimal set-points of dissolved oxygen S_{O}*; if MOPSO does not reach the preset maximum number of evolutions N₂, return to step \textcircled{5};

(4) design the controller based on the predictive control strategy:

\textcircled{1} define the cost functions in the predictive control strategy:

$${J}_{1} ( t ) = \frac{1}{2} {\sum }_{q = 1}^{5} {( {z}_{1} ( t ) - {y}_{1} ( t ) )}^{2} + \frac{1}{2} {\sum }_{m = 1}^{4} Δ {u ( t )}^{T} Δ u ( t ) , \\ {J}_{2} ( t ) = \frac{1}{2} {\sum }_{q = 1}^{5} {( {z}_{2} ( t ) - {y}_{2} ( t ) )}^{2} + \frac{1}{2} {\sum }_{m = 1}^{4} Δ {u ( t )}^{T} Δ u ( t ) , \qquad ( 12 )$$

where z₁(t) and z₂(t) are the optimal set-points of S_{O}* and S_{NO}*, y₁(t) and y₂(t) are the predicted values of S_{O} and S_{NO};

\textcircled{2} update control laws based on the predictive control strategy, the updated rule is:

u(t+1)=u(t)+Δu(t), (13)

where Δu(t) is the control law at time t, Δu(t) are control variations, whose expressions are shown as:

Δu₁(t)=½∂J₁(t)/∂u₁(t)+½∂J₂(t)/∂u₁(t),

Δu₂(t)=½∂J₁(t)/∂u₂(t)+½∂J₂(t)/∂u₂(t), (14)

where Δu(t) are the variations of the manipulated variables oxygen transfer coefficient ΔK_{L}a and internal recycle ΔQₐ, Δu(t)=[Δu₁(t), Δu₂(t)];

\textcircled{3} transfer the obtained ΔK_{L}a and ΔQₐ to the actual system of WWTP;

(3) the inputs of the cooperative optimal control based wastewater treatment system is ΔK_{L}a and ΔQₐ, the outputs of the wastewater treatment system is S_{O} and S_{NO}, the effect of the optimal control results is reflected by daily average of PE value, the daily average of AE value, the daily average of EQ value, and the tracking control results of S_{O} and S_{NO}.

The Novelties of this Present Disclosure Contain:

(1) Since WWTP is a complex and dynamic biochemical reaction process, conflicts with coupling performance indices, it is necessary to coordinate the performance indices in this present invention, and then improve the system performance, as well as guarantee the efficient and stable operation. However, due to the nonlinearity, strong coupling feature, and the conflicted multiple time-scale performance indices, it is difficult to realize the optimal control in WWTP. According to the operation features, a COCS method based on the cooperation optimization algorithm and predictive control strategy is proposed, which can balance the coupling performance indices and improve the operation efficiency.

(2) In this present invention, a COCS based on the cooperation optimization algorithm and predictive control strategy is studied to realize the optimal control in WWTP. This proposed optimal control method can efficiently capture the dynamic features of the performance indices, and acquire the optimal set-points of S_{O} and S_{NO} based on the dynamic working scenarios. Moreover, this proposed COCS can improve the optimization indices, and optimize the control performance.

Attention: for the convenient description, a data-driven assisted model based cooperative optimization algorithm and a predictive control strategy are used to describe and optimize the performance index, and trace the optimal set-points of S_{O} and S_{No}. The other optimal control methods based on different optimization algorithm and control strategy also belong to the scope of this present invention.

### BRIEF DESCRIPTION OF THE DRAWINGS

FIG. 1 shows the control system scheme of WWTP.

FIG. 2 shows the results of PE in COCS.

FIG. 3 shows the results of AE in COCS.

FIG. 4 shows the results of EQ in COCS.

FIG. 5 shows the results of S_{O} in COCS.

FIG. 6 shows the results of S_{NO} in COCS.

FIG. 7 is a chart showing the contribution degree index of process variables.

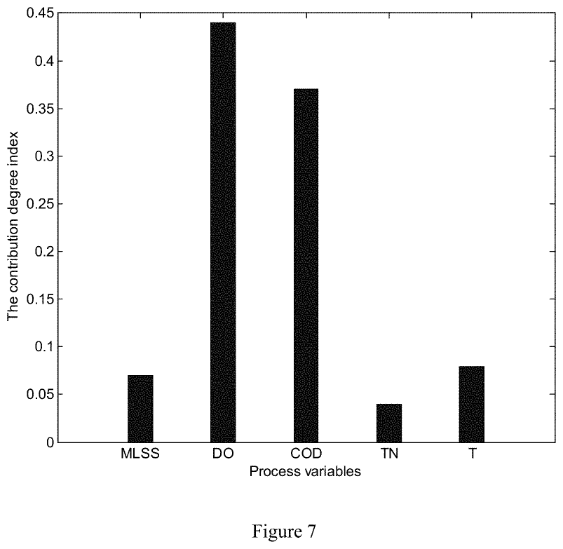

### DETAILED DESCRIPTION

(1) The design of the control system framework for WWTP, the steps are:

1) the control system includes the serve, the PLC control cabinet, the blower, an ORP electrode sensor, a S_{O} sensor, a SS sensor, a temperature sensor, a pH sensor, a S_{NH} sensor, a TN sensor, a COD sensor, where

the serve is the operation center of control system to optimize the control procedure and realize the monitoring functions;

the PLC control cabinet is used to complete the automatic detection, monitor and control of the equipment status and operation conditions;

the blower acts as an executor of the control system to realize the aeration and ventilation of aerobic tank;

an ORP electrode sensor, located in the anaerobic tank, is configured to measure the values of ORP;

a S_{O} sensor, located in the aerobic tank, is configured to measure the values of S_{O};

a SS sensor, located in the aerobic tank, is configured to measure the values of SS;

a temperature sensor, located in the effluent tank, is configured to measure the values of temperature;

a pH sensor, located in the in the effluent tank, is configured to measure the values of pH;

a S_{NH} sensor, located in the effluent tank, is configured to measure the values of S_{NH};

a TN sensor, located in the effluent tank, is configured to measure the values of TN;

a COD sensor, located in the effluent tank, is configured to measure the values of COD;

2) data collection and transmission, at first, it is necessary to achieve the data acquisition through an ORP electrode sensor, a S_{O} sensor, a SS sensor, a temperature sensor, a pH sensor, a S_{NH} sensor, a TN sensor, a COD sensor; then it is essential to connect PLC and the sensors by using RS 485, realize the communication, complete the upload of the collected data, and transfer the collected data to servers through coordinated communication standards;

(2) the optimal controller, which comprises the establishment of the performance indices, the development of the optimization algorithm and the design of the controller, the steps are:

1) select the related process variables of PE: S_{NO}, MLSS, and choose the related process variables of AE and EQ: S_{O}, SS, S_{NH}, S_{NO};

2) formulate the two-level models based on the different time scales, the upper-level model is for PE, and the lower-level models are for AE and EQ:

F₁(t₁)=l₁(xᵤ(t₁)), (1)

f₁(t₂)=l₂(xₗ(t₂),xᵤ*(t₁)),

f₂(t₂)=l₃(xₗ(t₂),xᵤ*(t₁)), (2)

where F₁(t₁) is the model for PE at time t₁, l₁(xᵤ(t₁)) is the mapping function of PE model, f₁(t₂) is the model for AE at time t₂, l₂(xₗ(t₂), x*ᵤ(t₁)) is the mapping function of AE model, x*ᵤ(t₁) is the optimal set-points of nitrate nitrogen S_{NO}* at time t₁, f₂(t₂) is the model for EQ at time t₂, l₃(xₗ(t₂), x*ᵤ(t₁)) is the mapping function of EQ model, xᵤ(t₁)=[S_{NO}(t₁), MLSS(t₁)] is the input variables vector of PE at time t₁, S_{NO}(t₁) is the concentration of S_{NO} at time t₁, MLSS(t₁) is the concentration of MLSS at time t₁, and the initial values of the two variables are [0.85, 1.56], xₗ(t₂)=[S_{O}(t₂), SS(t₂), S_{NH}(t₂)], S_{O}(t₂) is the concentration of S_{O} at time t₂, SS(t₂) is the concentration of SS at time t₂, S_{NH}(t₂) is the concentration of S_{NH} at time t₂, and [S_{O}(t₂), SS(t₂), S_{NH}(t₂), S_{NO}*(t₁)] is the input variables vector of AE and EQ at time t₂, and the initial values are [1.9, 11.6, 3.8, 0.95];

(3) design a cooperative optimization algorithm to optimize upper-level and lower-level optimization problems to obtain the optimal set-points of the control variables, where the optimization period in the upper level is two hours, in the lower level is thirty minutes, the steps are:

\textcircled{1} formulate the upper-level and lower-level problems:

Min F₁(S_{NO}(t₁),MLSS(t₁)), (3)

Min[f₁(S_{O}(t₂),S_{NH}(t₂),SS(t₂),S_{NO}*(t₁)),

f₂(S_{O}(t₂),S_{NH}(t₂),SS(t₂),S_{NO}*(t₁))], (4)

where Min F₁(S_{NO}(t₁), MLSS(t₁)) is the upper-level optimization problem, Min [f₁(S_{O}(t₂), S_{NH}(t₂), SS(t₂), S_{NO}*(t₁)), f₂(S_{O}(t₂), S_{NH}(t₂), SS(t₂), S_{NO}*(t₁))] is the lower-level optimization problem;

\textcircled{2} set the number of the particle population in the upper level optimization I₁, the number of the particle population in the lower level optimization I₂, the maximum number of iterations in the upper level optimization N₁, and the maximum number of iterations in the lower level optimization N₂, I₁=50, I₂=50, N₁=20, N₂=50;

\textcircled{3} introduce the single particle swarm optimization (SPSO) algorithm to optimize the upper-level optimization problem, the position and the velocity of the ith particle can be shown as:

sᵢ(t₁)=[s_{i,1}(t₁),s_{i,2}(t₁)], (5)

vᵢ(t₁)=[v_{i,1}(t₁),v_{i,2}(t₁)], (6)

sᵢ(t₁) is the position of the ith particle at time t₁, s_{i,1}(t₁) is the value of S_{NO} at time t₁, s_{i,2}(t₁) is the value of MLSS at time t₁, vᵢ(t₁) is the velocity of the ith particle at time t₁, i is the number of particles, i=1, 2, . . . , 50, an update process of sᵢ(t₁) and vᵢ(t₁) are

v_{i,d}(t₁+1)=0.7v_{i,d}(t₁)+0.72(p_{i,d}(t₁)−s_{i,d}(t₁))+0.72₂(g_{d}(t₁)−s_{i,d}(t₁)), (7)

s_{i,d}(t₁+1)=s_{i,d}(t₁)+v_{i,d}(t₁+1), (8)

where d is the space dimension, d=1, 2, v_{i,d}(t₁) is the velocity of the ith particle in the dth dimension at time t₁, p_{i,d}(t₁) is the individual optimal solution of the ith particle in the dth dimension at time t₁, g_{d}(t₁) is the global optimal solutions of the ith particle at time t₁;

\textcircled{4} if SPSO reaches the preset maximum number of evolutions N₁, stop the iterative evolution process, transfer the value of S_{NO}* to the lower level; if SPSO does not reach the preset maximum number of evolutions N₁, return to step \textcircled{3};

\textcircled{5} introduce the multiobjective particle swarm optimization (MOPSO) algorithm to optimize the lower-level optimization problem, the position of the jth particle aⱼ(t₂) and the velocity of the jth particle bⱼ(t₂) can be represented as aⱼ(t₂)=[a_{j,1}(t₂), a_{j,2}(t₂), a_{j,3}(t₂), a_{j,4}(t₂)], a_{i,1}(t₂) represents the value of S_{O} at time t₂, a_{i,2}(t₂) represents the value of S_{NH} at time t₂, a_{i,3}(t₂) represents the value of SS at time t₂, a_{i,4}(t₂) represents the value of S_{NO}* at time t₂, bⱼ(t₂)=[b_{j,1}(t₂), b_{j,2}(t₂), b_{j,3}(t₂), b_{j,4}(t₂)], j is the number of particles, j=1, 2, . . . , 50; during the iterative evolution process, the obtained non-dominated solutions are conserved in the external archive Z(t₂), Z(t₂)=[z₁(t₂), z₂(t₂), . . . , zⱼ(t₂), . . . , z₅₀(t₂)], the update rule of the external archive is:

žⱼ(t₂)=zⱼ(t₂)+0.09∇D(zⱼ(t₂)), (9)

where zⱼ(t₂) is the jth non-dominated solution at time t₂ before the archive is updated, žⱼ(t₂) is the jth non-dominated solution at time t₂ after the archive is updated, zⱼ(t₂)=[z_{j,1}(t₂), z_{j,2}(t₂)], žⱼ(t₂)=[ž_{j,1}(t₂), ž_{j,2}(t₂)], z_{j,1}(t₂) and ž_{j,1}(t₂) are the values of S_{O} before and after the archive is updated, z_{j,2}(t₂) and ž_{j,2}(t₂) are the values of S_{NO} before and after the archive is updated, ∇D is the gradient descent direction;

\textcircled{6} establish the multi-input-multi-output radial basis assisted model (RBSM) based on the non-dominated solutions in Z(t₂):

$${B}_{j} ( {t}_{2} ) = {\sum }_{k = 1}^{8} {o}_{j , k} ( {t}_{2} ) \times {θ}_{j , k} ( {t}_{2} ) , \qquad ( 10 )$$

where Bⱼ(t₂) is the output vector of RBSM, Bⱼ(t₂)=[B_{j,1}(t₂), B_{j,2}(t₂)]^{T}, B_{j,1}(t₂) is the predicted value of the aeration energy at time t₂, B_{j,2}(t₂) is the predicted value of the effluent quality at time t₂, oⱼ(t₂)=[o_{j,1}(t₂), o_{j,2}(t₂), . . . , o_{j,8}(t₂)]^{T} are the connection weights, θⱼ(t₂)=[θ_{j,1}(t₂), θ_{j,2}(t₂), . . . , θ_{j,8}(t₂)]^{T} is the output vector of the neurons in hidden layer, the sum of the squared errors between the output of RBSM and the actual system is expressed as

e(zₙ(t₂))=min(Bₙ(t₂)−Q(t₂))^{T}(Bₙ(t₂)−Q(t₂)), (11)

where e(zₙ(t₂)) is the sum of the squared errors between the outputs of the nth non-dominated solution Bₙ(t₂) and the actual system Q(t₂), n∈[1, 50], Q(t₂)=[Q₁(t₂), Q₂(t₂)] is the real outputs of AE and EQ in the actual system, select the solution corresponding to the minimal sum of the squared error as the global optimal solution;

\textcircled{7} if MOPSO reaches the preset maximum number of evolutions N₂, stop the iterative evolution process and output the optimal set-points of dissolved oxygen S_{O}*; if MOPSO does not reach the preset maximum number of evolutions N₂, return to step \textcircled{5};

(4) design the tracking control method based on the predictive control strategy:

\textcircled{1} define the cost functions in the predictive control strategy:

$${J}_{1} ( t ) = \frac{1}{2} {\sum }_{q = 1}^{5} {( {z}_{1} ( t ) - {y}_{1} ( t ) )}^{2} + \frac{1}{2} {\sum }_{m = 1}^{4} Δ {u ( t )}^{T} Δ u ( t ) , \\ {J}_{2} ( t ) = \frac{1}{2} {\sum }_{q = 1}^{5} {( {z}_{2} ( t ) - {y}_{2} ( t ) )}^{2} + \frac{1}{2} {\sum }_{m = 1}^{4} Δ {u ( t )}^{T} Δ u ( t ) , \qquad ( 12 )$$

where z₁(t) and z₂(t) are the optimal set-points of S_{O}* and S_{NO}*, y₁(t) and y₂(t) are the predicted values of S_{O} and S_{NO};

\textcircled{2} update the control laws based on the predictive control strategy, the updated rule is:

u(t+1)=u(t)+Δu(t), (13)

where Δu(t) is the control law at time t, Δu(t) are the control variations, whose expressions are shown as:

$$Δ {u}_{1} ( t ) = \frac{1}{2} \partial {J}_{1} ( t ) / \partial {u}_{1} ( t ) + \frac{1}{2} \partial {J}_{2} ( t ) / \partial {u}_{1} ( t ) , \\ Δ {u}_{2} ( t ) = \frac{1}{2} \partial {J}_{1} ( t ) / \partial {u}_{2} ( t ) + \frac{1}{2} \partial {J}_{2} ( t ) / \partial {u}_{2} ( t ) , \qquad ( 14 )$$

where Δu(t) are the variations of the manipulated variables oxygen transfer coefficient ΔK_{L}a and internal recycle ΔQₐ, Δu(t)=[Δu₁(t), Δu₂(t)];

\textcircled{3} transfer the obtained ΔK_{L}a and ΔQₐ to the actual system of WWTP;

(3) the inputs of the cooperative optimal control based wastewater treatment system is ΔK_{L}a and ΔQₐ, the outputs of the wastewater treatment system is S_{O} and S_{NO}, the effect of the optimal control results is reflected by the daily average of PE value, the daily average of AE value, the daily average of EQ value, and the tracking control results of S_{O} and S_{NO}.

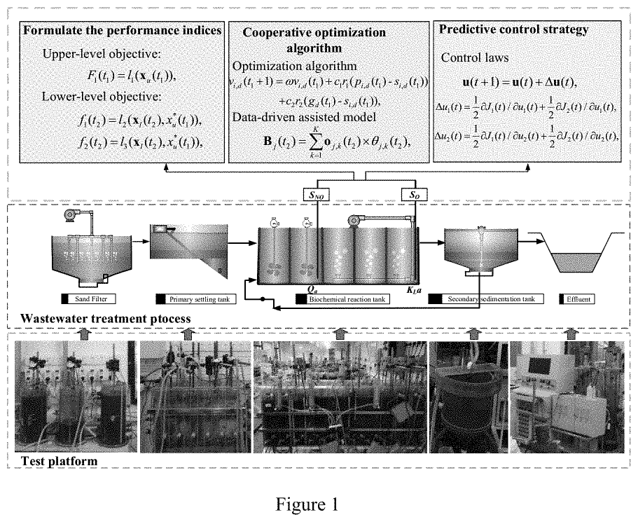

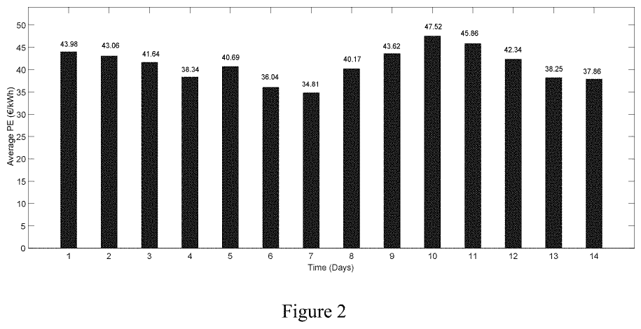

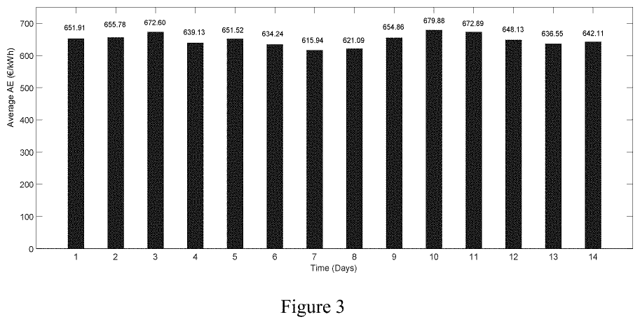

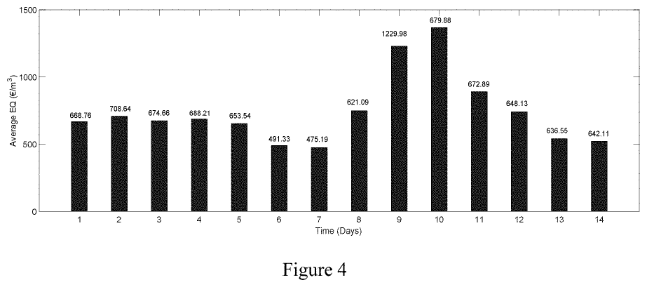

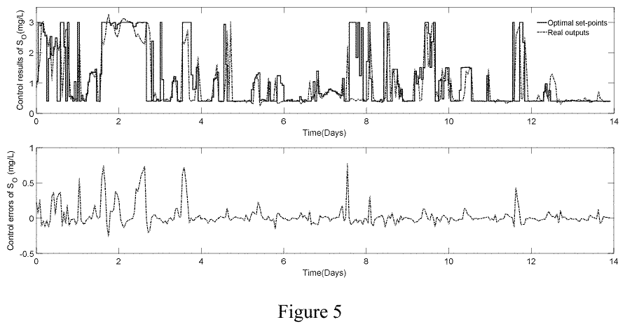

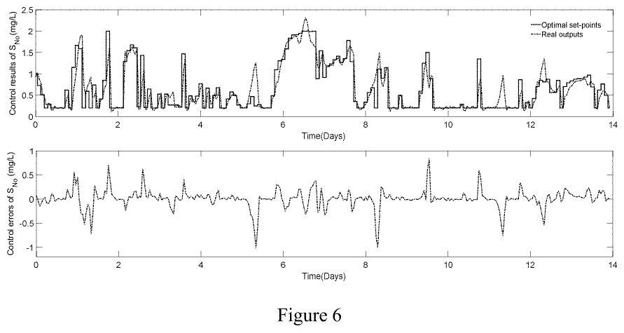

The control system scheme based on COCS is shown in FIG. 1, and the optimal control results are presented in FIGS. 2-6. FIG. 2 gives the daily average PE values, X axis shows the time, and the unit is day, Y axis is the average PE value, and the unit is €/KWh. FIG. 3 gives the daily average AE values, X axis shows the time, and the unit is day, Y axis is the average AE value, and the unit is €/KWh. FIG. 4 gives the daily average EQ values, X axis shows the time, and the unit is day, Y axis is the average EQ value, and the unit is €/m³. FIG. 5(a) gives S_{O} values, X axis shows the time, and the unit is day, Y axis is control results of S_{O}, and the unit is mg/L. FIG. 5(b) gives the control errors of S_{O}, X axis shows the time, and the unit is day, Y axis is control errors of S_{O}, and the unit is mg/L. FIG. 6(a) gives the S_{NO} values, X axis shows the time, and the unit is day, Y axis is control results of S_{NO}, and the unit is mg/L. FIG. 6(b) gives the control errors of S_{NO}, X axis shows the time, and the unit is day, Y axis is control errors of S_{NO}, and the unit is mg/L.

What is claimed is:

1. A cooperative optimal control method for wastewater treatment process (WWTP), comprising the following steps:
(1) select process variables of pumping energy, which include nitrate nitrogen (S_{NO}), mixed liquor suspended solids (MLSS), and choose process variables of aeration energy and the effluent quality, which include dissolved oxygen (S_{O}), suspended solids (SS), ammonia nitrogen (S_{NH}), S_{NO};
(2) formulate two-level models based on different time scales, wherein an upper-level model is designed for the pumping energy, and lower-level models are designed for the aeration energy and effluent quality:
F₁(t₁)=l₁(xᵤ(t₁)), (1)
f₁(t₂)=l₂(xₗ(t₂),xᵤ*(t₁))
f₂(t₂)=l₃(xₗ(t₂),xᵤ*(t₁)), (2)
where F₁(t₁) is a model of the pumping energy at time t₁, l₁(xᵤ(t₁)) is a mapping function of the pumping energy model, f₁(t₂) is a model of the aeration energy at time t₂, l₂(xₗ(t₂), x*ᵤ(t₁)) is a mapping function of the aeration energy model, x*ᵤ(t₁) is an optimal set-points of nitrate nitrogen S_{NO}* at time t₁, f₂(t₂) is a model of the effluent quality at time t₂, l₃(xₗ(t₂), x*ᵤ(t₁)) is a mapping function of the effluent quality model, xᵤ(t₁)=[S_{NO}(t₁), MLSS(t₁)] is input variables vector of the pumping energy at time t₁, S_{NO}(t₁) is concentration of nitrate nitrogen S_{NO} at time t₁, MLSS(t₁) is concentration of the mixed liquor suspended solids MLSS at time t₁, xₗ(t₂)=[S_{O}(t₂), SS(t₂), S_{NH}(t₂)], S_{O}(t₂) is concentration of S_{O} at time t₂, SS(t₂) is concentration of SS at time t₂, S_{NH}(t₂) is concentration of S_{NH} at time t₂, and [S_{O}(t₂), SS(t₂), S_{NH}(t₂), S_{NO}*(t₁)] are input variables vector of the aeration energy and effluent quality at time t₂;
(3) design a cooperative optimization algorithm to optimize upper-level and lower-level optimization problems to obtain optimal set-points of control variables, an optimization period of upper level is two hours, and an optimization period of lower level is thirty minutes, which includes:
\textcircled{1} formulate the upper-level and lower-level problems:
Min F₁(S_{NO}(t₁),MLSS(t₁)), (3)
Min[f₁(S_{O}(t₂),S_{NH}(t₂),SS(t₂),S_{NO}*(t₁)),
f₂(S_{O}(t₂),S_{NH}(t₂),SS(t₂),S_{NO}*(t₁))], (4)
where Min F₁(S_{NO}(t₁), MLSS(t₁)) is the upper-level optimization problem, Min [f₁(S_{O}(t₂), S_{NH}(t₂), SS(t₂), S_{NO}*(t₁)), f₂(S_{O}(t₂), S_{NH}(t₂), SS(t₂), S_{NO}*(t₁))] is the lower-level optimization problem;
\textcircled{2} set the number of particle population in the upper level optimization I₁, the number of the particle population in the lower level optimization I₂, a maximum number of iterations in the upper level optimization N₁, and a maximum number of iterations in the lower level optimization N₂, I₁=50, I₂=50, N₁=20, N₂=50;
\textcircled{3} introduce a single particle swarm optimization (SPSO) algorithm to optimize the upper-level optimization problem, a position and a velocity of the ith particle are:
sᵢ(t₁)=[s_{i,1}(t₁),s_{i,2}(t₁)], (5)
vᵢ(t₁)=[v_{i,1}(t₁),v_{i,2}(t₁)], (6)
sᵢ(t₁) is the position of the ith particle at time t₁, s_{i,1}(t₁) is the value of S_{NO} at time t₁, s_{i,2}(t₁) is the value of MLSS at time t₁, vᵢ(t₁) is the velocity of the ith particle at time t₁, i is the number of particles, i=1, 2, . . . , 50, an update process of sᵢ(t₁) and vᵢ(t₁) is
v_{i,d}(t₁+1)=0.7v_{i,d}(t₁)+0.72(p_{i,d}(t₁)−s_{i,d}(t₁))+0.72₂(g_{d}(t₁)−s_{i,d}(t₁)), (7)
s_{i,d}(t₁+1)=s_{i,d}(t₁)+v_{i,d}(t₁+1), (8)
where d is the space dimension, d=1, 2, v_{i,d}(t₁) is the velocity of the ith particle in the dth dimension at time t₁, p_{i,d}(t₁) is the individual optimal solution of the ith particle in the dth dimension at time t₁, g_{d}(t₁) is the global optimal solutions of the ith particle at time t₁;
\textcircled{4} if SPSO reaches a preset maximum number of evolutions N₁, stop the iterative evolution process, transfer the value of S_{NO}* to the lower level; if SPSO does not reach the preset maximum number of evolutions N₁, return to step \textcircled{3};
\textcircled{5} introduce a multiobjective particle swarm optimization (MOPSO) algorithm to optimize the lower-level optimization problem, the position of the jth particle aⱼ(t₂) and the velocity of the jth particle bⱼ(t₂) can be represented as aⱼ(t₂)=[a_{j,1}(t₂), a_{j,2}(t₂), a_{j,3}(t₂), a_{j,4}(t₂)], a_{i,1}(t₂) represents the value of S_{O} at time t₂, a_{i,2}(t₂) represents the value of S_{NH} at time t₂, a_{i,3}(t₂) represents the value of SS at time t₂, a_{i,4}(t₂) represents the value of S_{NO}* at time t₂, bⱼ(t₂)=[b_{j,1}(t₂), b_{j,2}(t₂), b_{j,3}(t₂), b_{j,4}(t₂)], j is the number of particles, j=1, 2, . . . , 50; during the iterative evolution process, the obtained non-dominated solutions are conserved in the external archive Z(t₂), Z(t₂)=[z₁(t₂), z₂(t₂), . . . , zⱼ(t₂), . . . , z₅₀(t₂)], the update rule of the external archive is:
žⱼ(t₂)=zⱼ(t₂)+0.09∇D(zⱼ(t₂)), (9)
where zⱼ(t₂) is the jth non-dominated solution at time t₂ before the archive is updated, žⱼ(t₂) is the jth non-dominated solution at time t₂ after the archive is updated, zⱼ(t₂)=[z_{j,1}(t₂), z_{j,2}(t₂)], žⱼ(t₂)=[ž_{j,1}(t₂), ž_{j,2}(t₂)], z_{j,1}(t₂) and ž_{j,1}(t₂) are the values of S_{O} before and after the archive is updated, z_{j,2}(t₂) and ž_{j,2}(t₂) are the values of S_{NO} before and after the archive is updated, ∇D is the gradient descent direction;
\textcircled{6} establish a multi-input-multi-output radial basis assisted model (RBSM) based on the non-dominated solutions in Z(t₂):
$${B}_{j} ( {t}_{2} ) = {\sum }_{k = 1}^{8} {o}_{j , k} ( {t}_{2} ) \times {θ}_{j , k} ( {t}_{2} ) , \qquad ( 10 )$$
where Bⱼ(t₂) is an output vector of RBSM, Bⱼ(t₂)=[B_{j,1}(t₂), B_{j,2}(t₂)]^{T}, B_{j,1}(t₂) is a predicted value of the aeration energy at time t₂, B_{j,2}(t₂) is a predicted value of the effluent quality at time t₂, oⱼ(t₂)=[o_{j,1}(t₂), o_{j,2}(t₂), . . . , o_{j,8}(t₂)]^{T} are connection weights, θⱼ(t₂)=[θ_{j,1}(t₂), θ_{j,2}(t₂), . . . , θ_{j,8}(t₂)]^{T} is an output vector of the neurons in hidden layer, the sum of the squared errors between the output of RBSM and the actual system is expressed as
e(zₙ(t₂))=min(Bₙ(t₂)−Q(t₂))^{T}(Bₙ(t₂)−Q(t₂)), (11)
where e(zₙ(t₂)) is the sum of the squared errors between the outputs of the nth non-dominated solution Bₙ(t₂) and the actual system Q(t₂), n∈[1, 50], Q(t₂)=[Q₁(t₂), Q₂(t₂)] is the real outputs of the aeration energy and effluent quality in the actual system, select the solution corresponding to the minimal sum of the squared error as the global optimal solution;
\textcircled{7} if MOPSO reaches a preset maximum number of evolutions N₂, stop the iterative evolution process and output the optimal set-points of dissolved oxygen S_{O}*; if MOPSO does not reach the preset maximum number of evolutions N₂, return to step \textcircled{5};
(4) design a controller based on predictive control strategy:
\textcircled{1} define cost functions in the predictive control strategy:
$${J}_{1} ( t ) = \frac{1}{2} {\sum }_{q = 1}^{5} {( {z}_{1} ( t ) - {y}_{1} ( t ) )}^{2} + \frac{1}{2} {\sum }_{m = 1}^{4} Δ {u ( t )}^{T} Δ u ( t ) , \\ {J}_{2} ( t ) = \frac{1}{2} {\sum }_{q = 1}^{5} {( {z}_{2} ( t ) - {y}_{2} ( t ) )}^{2} + \frac{1}{2} {\sum }_{m = 1}^{4} Δ {u ( t )}^{T} Δ u ( t ) , \qquad ( 12 )$$
where z₁(t) and z₂(t) are an optimal set-points of S_{O}* and S_{NO}*, y₁(t) and y₂(t) are predicted values of S_{O} and S_{NO};
\textcircled{2} update control laws based on the predictive control strategy, the updated rule is:
u(t+1)=u(t)+Δu(t), (13)
where Δu(t) is the control law at time t, Δu(t) are control variations, whose expressions are shown as:
Δu₁(t)=½∂J₁(t)/∂u₁(t)+½∂J₂(t)/∂u₁(t),
Δu₂(t)=½∂J₁(t)/∂u₂(t)+½∂J₂(t)/∂u₂(t), (14)
where Δu(t) are variations of the manipulated variables oxygen transfer coefficient ΔK_{L}a and internal recycle ΔQₐ, Δu(t)=[Δu₁(t), Δu₂(t)];
\textcircled{3} transfer the obtained ΔK_{L}a and ΔQₐ to an actual system of WWTP;
(5) inputs of a cooperative optimal control for the wastewater treatment system are ΔK_{L}a and ΔQₐ, outputs of the wastewater treatment system are S_{O} and S_{NO}, the effect of the optimal control results is reflected by the daily average of the pumping energy value, the daily average of the aeration energy value, the daily average of the effluent quality value, and the tracking control results of S_{O} and S_{NO}.
